(19) United States
(12) Patent Application Publication
(10) Pub. No.: US 2025/0271211 A1
(43) Pub. Date: Aug. 28, 2025

(54) FLASH DRYER

(71) Applicant: Exalant Drying Technology AB, Vinslöv (SE)

(72) Inventor: Richard KLANG, Vinslöv (SE)

(73) Assignee: Exalant Drying Technology AB, Vinslöv (SE)

(21) Appl. No.: 19/059,952

(22) Filed: Feb. 21, 2025

(30) Foreign Application Priority Data
Feb. 26, 2024 (SE) 2450227-0

(51) Int. Cl. F26B 17/10; F26B 5/08; F26B 7/00

(52) U.S. Cl. CPC F26B 17/103; F26B 5/08; F26B 7/007; F26B 17/107; F26B 2200/18

(57) ABSTRACT

A flash dryer for drying a product may include a chamber formed of a chamber wall. A product inlet may be provided for providing the product into the chamber. A gas inlet may be arranged below the product inlet for providing drying gas into the chamber. An outlet may be arranged above the product inlet. A gas distribution element may be arranged above the gas inlet. An outer edge of the gas distribution element may be distanced from the chamber wall such that a passage is formed between the gas distribution element and the chamber wall. A lower side of the gas distribution element may include a gas deflecting surface inclined relative to a horizontal plane such that the drying gas from the gas inlet is deflected by the gas deflecting surface towards the passage.

This application claims priority under 35 USC 119 (a)-(d) from Swedish Patent Application No. 2450227-0 filed Feb. 26, 2024, the entire contents of which are incorporated herein by reference.

### BACKGROUND

### 1. Technical Field

The present invention relates to flash dryers for drying a product, and in particular to a flash dryer comprising a gas distribution element with an inclined gas deflecting surface, and methods of operating the same.

### 2. Discussion of Related Art

A flash dryer is typically used for continuous drying of different products, such as products used for food or fodder. Known flash dryers rely on a generally upwards stream of hot air through a chamber. The hot air enters the chamber through an inlet at the bottom of the chamber and exits the chamber through an outlet at the top of the chamber. When the product to be dried is supplied to the chamber, the product is subjected to the hot air stream causing moisture in the wet product to be evaporated.

In known flash dryers, such as the flash dryer described in EP1719963A2, the air inlet is a tangential air inlet arranged towards a side of a lower part of the chamber. Such tangential air inlets are complicated and expensive to manufacture.

Typically, known flash dryers also use some form of rotating mills for disintegration of the product inside the chamber. The rotating mills are commonly driven by an externally located rotor drive (i.e. a rotor drive arranged below the chamber of the flash dryer) having an axle or shaft extending into the chamber to the rotating mill. Because the rotor drive is located outside the chamber, it is not subjected to the high heat experienced in the chamber.

A problem with this type of conventional flash dryer is that some product material tends to accumulate near the bottom of the chamber and/or in the air inlet. In general, accumulation of material, and in particular build-up of waste materials, at the bottom of a flash dryer and/or in the air inlet is difficult to handle as removal of this material generally requires the processing line to be shut down for maintenance, which may entail disassembling the flash dryer and long waiting times in order for the dryer to cool to temperatures which permit operator access to the chamber and/or the air inlet.

Embodiments of the present invention seek to provide enhanced flash dryer systems, methods and other implementations that provide efficient drying of a product and addresses disadvantageous aspects of known flash dryers as well as providing new functionality and methods.

### SUMMARY

The invention is defined by the appended independent claims. Additional features and advantages of the concepts disclosed herein are set forth in the description which follows, and in part will be obvious from the description, or may be learned by practice of the described technologies. The features and advantages of the concepts may be realized and obtained by means of the instruments and combinations particularly pointed out in the appended claims. These and other features of the described technologies will become more fully apparent from the following description and appended claims, or may be learned by the practice of the disclosed concepts as set forth herein.

In a first aspect, there is provided a flash dryer for drying a product, the flash dryer comprising: a chamber formed of a chamber wall, a product inlet for providing the product into the chamber, a gas inlet arranged below the product inlet for providing drying gas into the chamber, an outlet arranged above the product inlet, and a gas distribution element arranged above the gas inlet, wherein: an outer edge of the gas distribution element is distanced from the chamber wall such that a passage is formed between the gas distribution element and the chamber wall, and a lower side of the gas distribution element comprises a gas deflecting surface inclined relative to a horizontal plane such that the drying gas from the gas inlet is deflected by the gas deflecting surface towards the passage.

The flash dryer according to the first aspect is more compact and less complex to manufacture than conventional flash dryers. Furthermore, the gas distribution element ensures an efficient gas flow through the flash dryer. The flash dryer according to the first aspect further reduces the risk of any product accumulating and/or getting stuck in undesirable places, and in particular in the gas inlet portion of the chamber. Hence, the flash dryer is more hygienic making it more suitable for drying of food products, while the risk of ignition and/or explosion of accumulated material is reduced. Furthermore, a down-time required for maintenance and/or cleaning of the flash dryer is reduced and/or removed.

The gas inlet may be arranged vertically below the gas distribution element. Additionally, the gas inlet may be arranged to provide a substantially vertical gas flow into the chamber before the gas flow is deflected by the gas deflecting surface. This is advantageous because it ensures that the gas flow through the passage will carry any product material that has fallen down through the passage back up into the drying portion of the chamber.

Optionally, the gas inlet is a centrally arranged gas inlet. This may be combined with a cylindrical chamber, with an annular passage, and wherein the gas distribution element and/or the gas deflecting surface is rotationally symmetric. Hence, it can be ensured that the gas flow through the passage is rotationally symmetric.

Optionally, the gas deflecting surface is inclined, relative to a horizontal plane, between a first section near the outer edge and a second section away from the outer edge such that the second section is located below the first section.

Optionally, the gas distribution element is formed by an outer wall defining an internal cavity and wherein a drive unit is arranged inside the internal cavity of the gas distribution element, wherein the drive unit is connected to a drive shaft extending through an upper surface of the gas distribution element into the chamber. Accordingly, the flash dryer may be made more compact than conventional flash dryers while allowing a gas inlet to be positioned directly below the gas distribution element. Optionally, the gas distribution element is provided with one or more fluid circuits connected to the drive unit wherein the flash dryer is configured to circulate cooling fluid through the fluid circuits to cool the drive unit.

Optionally, the flash dryer comprises a plurality of rotatable disintegrator elements arranged above the gas distribution element and connected to the drive shaft. The rotatable disintegrator elements may be used to disintegrate the product while also inducing a tangential velocity to the gas flow.

Optionally, the flash dryer further comprises one or more adjustable flaps arranged in the chamber for controlling a tangential velocity of the gas flow. Hence, a centrifugal force acting on the product may be controlled by the flaps. This is particularly advantageous during the start-up procedure as well as during an emptying of the chamber because the flaps have been found to alleviate the need for a slow and gradual change in rotational velocity of the disintegrator during these stages.

Optionally, the adjustable flaps are adjustable, preferably by rotation, between a first position and a second position, wherein in the first position a plane of each flap is inclined relative a vertical, and wherein in the second position the plane of each flap is substantially vertical. Alternatively, or additionally, the flaps may be adjustable between two or more of the following positions: (i) a position where the flaps are substantially horizontal, (ii) a position where the flaps are inclined relative to the horizontal and/or vertical, and/or (iii) a position where the flaps are substantially vertical.

Optionally, the flaps are located above the passage, preferably above the disintegrator elements.

In a second aspect, there is provided a flash dryer for drying a product, the flash dryer comprising: a chamber formed of a chamber wall, a product inlet for providing the product into the chamber, a gas inlet arranged below the product inlet for providing drying gas into the chamber, an outlet arranged above the product inlet, and one or more adjustable flaps arranged in the chamber for controlling a tangential velocity of the gas flowing through the chamber.

The flash dryer according to the second aspect allows a centrifugal force acting on the product to be controlled by the flaps. This is particularly advantageous during the start-up procedure as well as during an emptying of the chamber because the flaps have been found to alleviate the need for a slow and gradual change in rotational velocity of the disintegrator during these stages.

Optionally, the adjustable flaps are adjustable, preferably by rotation, between a first position and a second position, wherein in the first position a plane of each flap is inclined relative a vertical, and wherein in the second position the plane of each flap is substantially vertical. Alternatively, or additionally, the flaps may be adjustable between two or more of the following positions: (i) a position where the flaps are substantially horizontal, (ii) a position where the flaps are inclined relative to the horizontal and/or vertical, and/or (iii) a position where the flaps are substantially vertical.

Optionally, the flaps are located above the passage, preferably above the disintegrator elements.

In a third aspect, there is provided a method of drying a product in a flash dryer, the method comprising: supplying a hot gas to a gas inlet of a chamber; deflecting the hot gas, by a gas deflecting surface of a gas distribution element towards a passage formed between the gas distribution element and a wall of the chamber such that the gas flows through the passage; feeding the product into the chamber through a product inlet; carrying the product upwards by the gas flowing through the passage; evaporating moisture in the product by the hot gas; and collecting the product at a product outlet of the chamber.

In a fourth aspect, there is provided a method of drying a product in a flash dryer, the method comprising: supplying a hot gas to a gas inlet of a chamber; feeding the product into the chamber through a product inlet; carrying the product upwards by the hot gas; evaporating moisture in the product by the hot gas; adjusting one or more flaps in the chamber from a first position to a second position so as to control, by the flaps, a tangential velocity of the flow of gas.

### BRIEF DESCRIPTION OF THE DRAWINGS

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 shows a schematic view of a flash dryer according to embodiments;

FIG. 2 shows a cross-sectional view from below of a flash dryer according to embodiments;

FIG. 3 shows a cross-sectional front view of a flash dryer according to embodiments;

FIG. 4 shows a cross-sectional perspective view of a flash dryer according to embodiments;

FIG. 5 shows a method of drying a product according to embodiments; and

FIG. 6 shows a method of drying a product according to embodiments. Further, in the figures like reference characters designate like or corresponding parts throughout the several figures. The first digit in the reference character denotes the first figure in which the corresponding element or part appears.

### DETAILED DESCRIPTION

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the spirit and scope of the claimed invention.

Hereinafter, certain embodiments will be described more fully with reference to the accompanying drawings. It will be apparent to those skilled in the art that various modifications and variations can be made without departing from the inventive concept. Other embodiments will be apparent to those skilled in the art from consideration of the specification and practice disclosed herein. It is to be understood that elements and materials may be substituted for those illustrated and described herein, parts and processes may be reversed or omitted, certain features may be utilized independently, and embodiments or features of embodiments may be combined, all as would be apparent to the skilled person in the art.

The embodiments herein are provided by way of example so that this disclosure will be thorough and complete, and will fully convey the scope of the inventive concept, and that the claims be construed as encompassing all modifications, equivalents and alternatives of the present inventive concept which are apparent to those skilled in the art to which the inventive concept pertains. If nothing else is stated, different embodiments may be combined with each other.

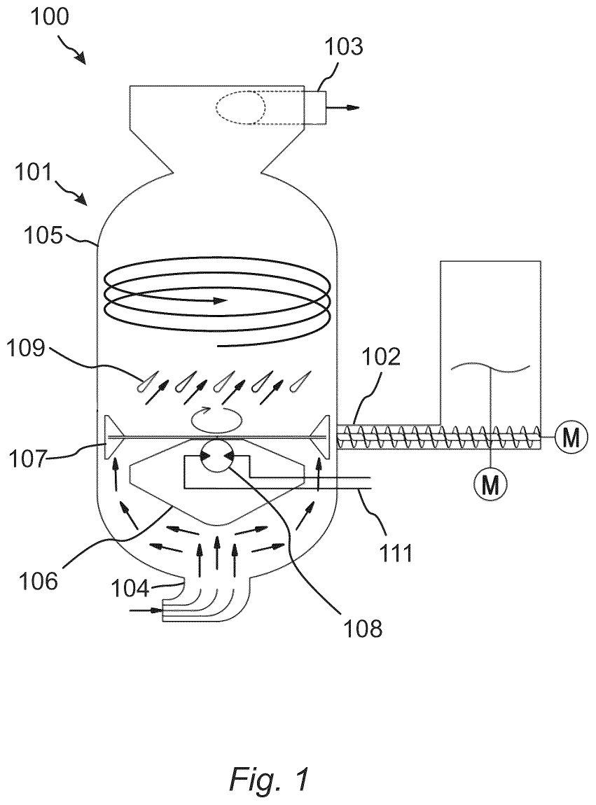

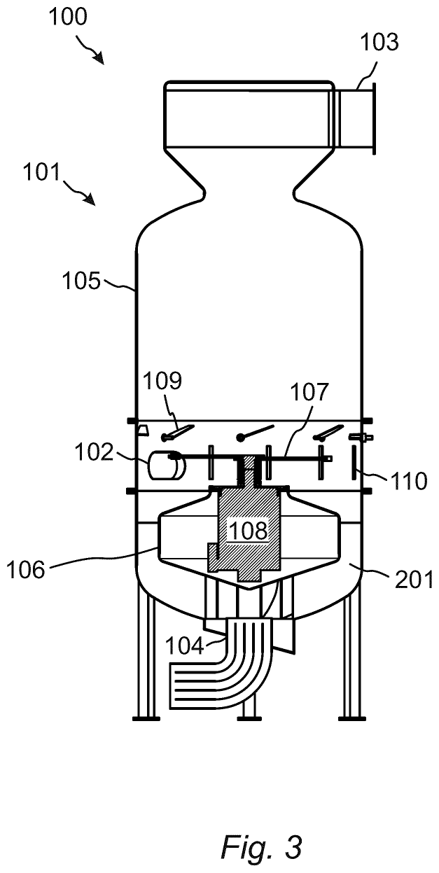

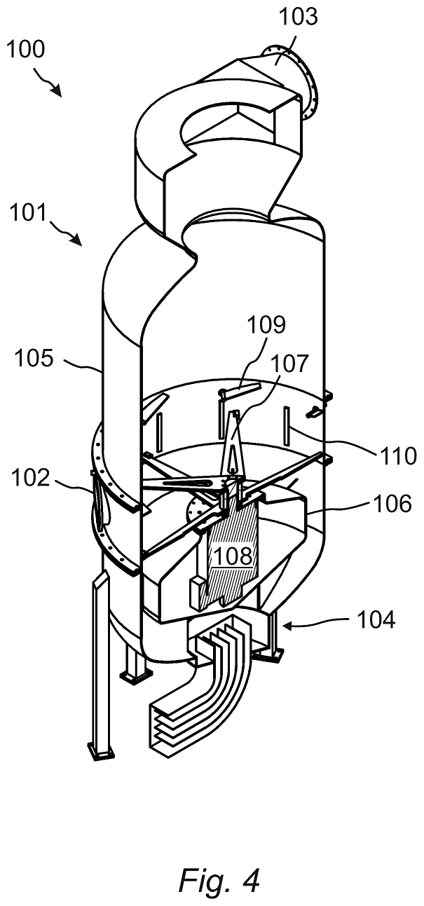

FIGS. 1 to 4 show different views of a flash dryer 100 according to embodiments. The flash dryer 100 is a dryer for drying a product. The flash dryer 100 relies on the principle of flash drying, which may be described as subjecting the product to be dried to a hot dry gas stream so as to evaporate moisture in the product very quickly.

The product to be dried may be in the form of a fibrous material, a filter cake, a paste, a sludge, and/or other similar materials. The product may be at least partially derived from plants and/or animals such as insects. Alternatively, the product may be an inorganic material. The product may, once dried, be a product intended for food, fodder, or the like.

The flash dryer 100 may, simultaneously with and/or before the drying of the product, be configured to disintegrate the product into smaller particles. This is particularly advantageous if the product to be dried has a paste-like and/or sludge-like structure which is typically very difficult to dry efficiently in a drying apparatus. The disintegration may thus cause a change in structure of the product, from the paste-like and/or sludge-like structure to a particle structure which can be more efficiently dried in a drying apparatus.

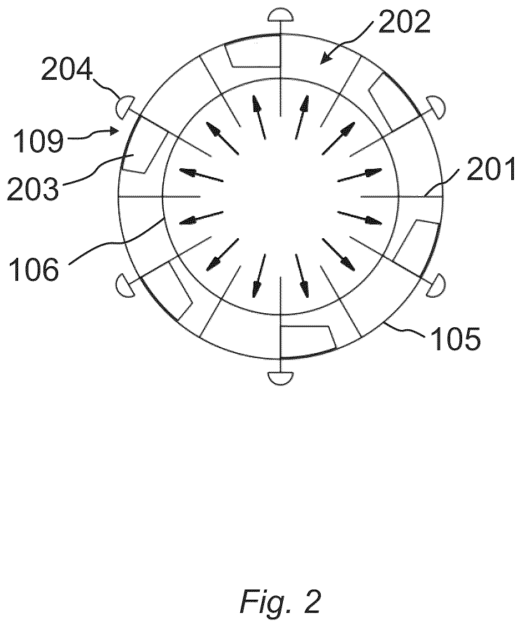

The flash dryer 100 according to embodiments comprises a chamber 101 where the drying process occurs, a product inlet 102 for supply of the product to be dried into the chamber 101, a product outlet 103 for delivery of dried product from the chamber 101, a gas inlet 104 for supply of hot gas for drying the product (also referred to as the drying gas) into the chamber 101, and a gas outlet 103 for exhaust of the drying gas from the chamber 101. The flow of drying gas through the flash dryer 100 is indicated by arrows in FIGS. 1 and 2.

The chamber 101 may be formed as a cavity or volume enclosed by a chamber wall 105, which may also be referred to as an outer chamber wall.

The chamber 101 may be elongate and extend vertically. That is, a longitudinal axis (such as the central axis of a cylinder) of the chamber 101 may extend in a vertical direction.

The chamber 101 may be cylindrical (e.g. a circular cylinder or an elliptic cylinder) or substantially cylindrical. In particular, at least a portion of the chamber 101 may be cylindrical. For example, a middle portion of the chamber 101 may be cylindrical while a bottom and/or top portion may be non-cylindrical.

Although reference will generally be made to a cylindrical chamber 101, it will be appreciated that embodiments include chambers of other shapes, such as cuboidal shape, prism shape (e.g. triangular prism, hexagonal prism), spherical or hemispherical shape, cone shape, or any other suitable shape.

The gas inlet 104 is preferably located near or at the bottom of the chamber 101, while the gas outlet 103 is preferably located near or at the top of the chamber 101. This allows for a generally upward stream of gas through the chamber 101.

The drying gas may comprise air, steam, and/or any other suitable gas for drying the product. The drying gas may, in addition to or as an alternative to air and/or steam, comprise flue gasses, exhaust gasses, or the like. The drying gas may be supplied at a temperature between 150 and 500 degrees Celsius. The drying gas may thus be referred to as a hot gas and/or a hot drying gas. However, once the drying gas reaches the gas outlet 103, the drying gas has typically cooled down (e.g. the temperature of the drying gas is lower at the gas outlet 103 than at the gas inlet 104) due to heat being transferred to evaporation of moisture in the product.

The product inlet 102 is typically located above the gas inlet 104. Thus, the upward stream of drying gas passes the product inlet 102 and thus subjects the product to be dried to the hot drying gas. Accordingly, the drying gas causes at least some of the moisture in the product to evaporate. The upward stream of drying gas will also carry the product with it (i.e. cause the product to move with the stream of gas) due to the buoyancy force exerted by the gas stream on the product.

The product inlet 102 may be provided on a side of the chamber 101, e.g. at a side wall of the chamber 101. The product inlet 102 may be orientated towards the centre of the chamber 101 (i.e. towards the central longitudinal axis of the chamber 101) such that the product enters the chamber 101 in a direction towards the centre of the chamber 101. It will be appreciated that the product inlet 102 may be formed by a single inlet or of a plurality of separate inlets.

The product inlet 102 may comprise any suitable structure for supplying the product into the chamber 101. For example, there may be provided a screw conveyor (e.g. a single or double screw type conveyor) for transporting the product into the chamber 101. Alternatively, or additionally, there may be provided other types of conveyors, pumps, or the like for supplying the product to the chamber 101. Yet alternatively, the product may be provided manually, for example to a funnel connected to the product inlet 102.

As moisture evaporates from the product, the weight of the product will decrease. The product will thus be lifted higher and higher by the gas stream (since gravity becomes relatively weaker compared to the lifting or buoyancy force of the gas stream), until a sufficient amount of moisture has been evaporated to allow the dried product to reach the product outlet 103.

The product outlet 103 is accordingly located above the product inlet 102, and preferably near or at the top of the chamber 101. In other words, the product outlet 103 is located closer to the top of the chamber 101 compared to the product inlet 102. In embodiments, the product outlet 103 and the gas outlet 103 may be combined in a single outlet as seen in FIGS. 1 to 4.

The length of the chamber 101 and/or the gas flow properties (such as mass flow, and/or temperature) may be determined in dependence on the desired drying results of the product. For example, the length of the chamber 101 and/or the gas flow properties may be determined in dependence on how moist the product to be dried is before entering the chamber 101 and/or the desired dryness of the dried product. As an example, a longer chamber 101 allows the product to circulate in the chamber 101 for a longer time and accordingly allows for more moisture to be evaporated.

The flash dryer 100 further comprises a gas distribution element 106 arranged in the chamber 101. The gas distribution element 106 is configured to distribute the gas from the gas inlet 104 to facilitate efficient drying of the product.

The gas distribution element 106 is arranged above the gas inlet 104 but below a portion of the chamber 101 where the drying of the product occurs. The gas distribution element 106 may thus be said to divide the chamber 101 into a gas inlet 104 portion of the chamber 101 (below the gas distribution element 106) and a drying portion of the chamber 101 (above the gas distribution element 106).

The gas distribution element 106 has a cross-section similar in shape to the cross-section of the chamber 101. For example, if the chamber 101 is cylindrical (i.e. with a circular cross-section), the gas distribution element 106 may have a circular cross-section.

However, a radius or width of the gas distribution element 106 is smaller than the radius or width of the chamber 101. Thus, when the gas distribution element 106 is arranged in the chamber 101, a passage 202 is formed around the gas distribution element 106, i.e. between an outer edge or side of the gas distribution element 106 and the chamber wall 105. In other words, the outer edge or side of the gas distribution element 106 is distanced from the chamber wall 105. The passage 202 may extend around the entire or substantially the entire outer edge or side of the gas distribution element 106. The passage 202 may also be referred to as a slit, constriction, and/or narrowing.

Hence, gas entering the chamber 101 through the gas inlet 104 will be distributed by the gas distribution element 106 and flow through the passage 202 towards the drying portion of the chamber 101. In other words, the passage 202 forms a fluid connection between the gas inlet portion of the chamber 101 and the drying portion of the chamber 101.

The cross-sectional area of the passage 202 may be smaller than a cross-sectional area of the gas inlet 104. In other words, the passage 202 is a narrow passage, a constriction and/or narrowing. Thus, gas flowing from the gas inlet 104 will accelerate as it flows through the passage 202.

Furthermore, due to the size of the passage 202 and the design of the gas distribution element 106, the gas will flow substantially vertically through the passage 202 in an upwards direction.

The gas distribution element 106 further comprises at least one gas deflecting surface configured to deflect the gas from the gas inlet 104 towards the passage 202. The gas deflecting surface is located on a lower side of the gas distribution element 106, i.e. on a side of the gas distribution element 106 closest to and/or facing the gas inlet 104. Thus, as the gas enters the chamber 101 through the gas inlet 104, the gas will flow towards the gas deflecting surface and be deflected towards the passage 202.

The gas deflecting surface may be inclined and/or slanted relative to the horizontal and/or a plane normal to the longitudinal axis of the chamber 101. Additionally, or alternatively, the gas deflecting surface may be inclined relative to the gas inlet 104 (i.e. relative to the streamlines of the gas flow at the gas inlet 104). Additionally, or alternatively, the gas deflecting surface may be inclined relative to the chamber wall 105, e.g. the chamber wall 105 surrounding the passage 202.

In particular, the gas deflecting surface may be inclined relative to the horizontal and/or a plane normal to the longitudinal axis of the chamber 101 by an angle of 5 to 85 degrees, optionally 10 to 75 degrees, optionally 15 to 65 degrees, optionally 20 to 55 degrees, optionally 22 to 45 degrees, optionally 25 to 35 degrees. A deflecting surface as described, which deflecting the gas towards the passage 202, has been found to reduce a pressure drop in the gas inlet portion of the chamber 101.

The gas deflecting surface may be straight and/or curved. A straight surface may also be referred to as a surface with constant inclination (or constant lack thereof) and/or with discrete changes in inclination between different (straight) sections of constant inclination. A curved surface may also be referred to as a surface with varying inclination (e.g. continuously varying inclination). The gas deflecting surface may also comprise one or more straight sections in combination with one or more curved sections. The gas deflecting surface, and/or any curved sections of the gas deflecting surface, may be convex or concave. A convex gas deflecting surface has been found to reduce the flow separation near the passage 202 (since it more closely follows the streamlines) and thus ensure a lower pressure drop.

The gas deflecting surface is preferably inclined between an inner section of the gas deflecting surface (i.e. a section relatively further from the outer edge of the gas deflecting surface) and an outer section of the gas deflecting surface (i.e. a section relatively closer to the outer edge of the gas deflecting surface). Preferably, the gas deflecting surface is inclined between a middle section and an outer section. Yet more preferably, the gas deflecting surface is inclined between a middle or central point or line of the gas deflecting surface to the outer edge of the gas deflecting surface.

The gas deflecting surface is preferably inclined upwards from the inner section to the outer section. That is, the inner section is preferably located below the outer section. In other words, the gas deflecting surface is inclined, from the inner section to the outer section, in the same direction as the flow of gas entering the chamber 101 from the gas inlet 104.

For a cylindrical chamber 101, the gas deflecting surface is preferably rotationally symmetric. For example, the gas deflecting surface may be inclined upwards from an inner annular section to an outer annular section. As another example, the gas deflecting surface may be inclined upwards from a central point to the outer edge. The gas deflecting surface may accordingly be configured to deflect the gas flow in a radial direction (i.e. an outward radial direction).

In embodiments, the gas deflecting surface forms a cone, a truncated cone, a dome, or truncated dome.

A bottom section of the chamber 101 may be shaped like a hemisphere or dome, or by another curved shape which substantially follows the streamlines of the gas flow in the gas inlet portion of the chamber 101. Thus, a pressure drop in the gas inlet portion of the chamber 101 may be reduced.

The deflecting surface and/or the bottom section of the chamber 101 may form a smooth surface to reduce turbulent gas flow and/or flow separation in the gas inlet portion of the chamber 101. In particular, the deflecting surface and/or the bottom section of the chamber 101 may lack any sharp corners or edges or the like.

The inclined gas deflecting surface is particularly advantageous when the gas inlet 104 is arranged vertically below the gas distribution element 106. For example, the gas inlet 104 may be arranged centrally at the bottom of the chamber 101. In other words, the gas inlet 104 may be arranged along the central longitudinal (or vertical) axis of the chamber 101.

Furthermore, the inclined gas deflecting surface is particularly advantageous when the gas inlet 104 is configured to provide gas flow in a vertical direction. The vertical gas inlet 104 may be combined with a gas deflecting surface which is rotationally symmetric to ensure that the gas flow through the passage 202 is rotationally symmetric, i.e. that the flow of gas is distributed uniformly around the passage 202 by the gas distribution element 106.

A gas inlet portion of the chamber 101 with a vertical gas inlet 104, a gas deflecting surface and/or a streamlined (e.g. smooth and/or curved) bottom part has been found to reduce the risk of any product accumulating and/or getting stuck in the gas inlet portion of the chamber 101. In particular, a vertical gas inlet 104 combined with a gas deflecting surface and a bottom chamber part with a streamlined shape ensures that the gas flow will carry any product material that has fallen down through the passage 202 back up through the passage 202 back into the drying portion of the chamber 101.

This is contrary to known flash dryers where, for example, a horizontal gas inlet is likely to experience problems with product material accumulating in the gas inlet and/or in crevices or edges formed in or around the gas inlet. A horizontal gas inlet is particularly prone to these problems as the horizontal gas flow is perpendicular to the direction of gravity.

Hence, the flash dryer 100 according to embodiments reduces the risk of product material accumulating in undesirable places. This is advantageous because accumulated product material may ignite (e.g. because of the high temperature in the chamber 101 due to the supply of hot gas) and/or cause explosions or the like. In addition, accumulated product material may be undesirable from a hygienic perspective, especially if the dried product is intended to be used as food, fodder, or for other consumable purposes. As a result, the downtime (e.g. for maintenance and/or cleaning) is reduced for the flash dryer 100 according to embodiments.

Furthermore, the flash dryer 100 according to embodiments is more compact and less complex to manufacture than conventional flash dryers with tangential air inlets.

The gas distribution element 106 may be fixedly arranged in the chamber 101. For example, the gas distribution element 106 may be held in place by one or more fixation elements 201 arranged between the gas distribution element 106 and the chamber wall 105 as seen in FIGS. 2 to 4. The fixation elements 201 may be arranged along the outer edge or periphery of the gas distribution element 106. In particular, the one or more fixation elements 201 may be arranged rotationally symmetrically around the gas distribution element 106, e.g. at least partly in the passage 202.

The fixation elements 201 may comprise thin vertical guides, vanes, or plates configured to guide the gas flow through the passage 202. The fixation elements 201 may thus help ensure that the stream of gas flows through the passage 202 in a substantially vertical direction.

The gas distribution element 106 may be located at least partly below the product inlet 102. In particular, the gas distribution element 106 may be arranged such that the passage 202 is located at least partly below the product inlet 102. In other words, the product inlet 102 may be located at or above the passage 202.

Thus, as the product enters the chamber 101, it will fall down towards the passage 202. The vertical flow of gas through the passage 202 will then impart an upward vertical velocity to the product. The product will thus be carried with the gas flow, during which time moisture will be evaporated from the product.

Accordingly, the product will circulate in the upwards gas flow, in the drying portion of the chamber 101, until sufficient moisture has been evaporated. Once sufficient moisture has been evaporated, the lifting force imposed by the gas flow overcomes the downward force of gravity and/or the centrifugal force, allowing the product to rise to, and exit through, the product outlet 103.

At the product outlet 103, the dried product is removed from the chamber 101. For example, the product may be removed together with the now cooled down drying gas through a combined product outlet 103 and gas outlet 103. At, or after, the product outlet 103, there may be provided one or more filters and/or cyclones for separating the dried product from the humid (i.e. moisture-containing) outlet gas.

A top section of the chamber 101 may include a dome shaped section and/or a diffuser section. In particular, the top of the drying section may form a domed wall surface followed by a diffuser, as can be seen in FIG. 1. The domed section and the diffuser section may be connected via a constriction or orifice. Thus, a cross-sectional area (and/or radius) of the chamber 101 may, towards the top of the chamber 101, first decrease (in the curved or domed section) followed by an increase in the diffuser section. Since the product experiences a centrifugal force while circulating in the chamber, the product will only be lifted into the diffuser section once sufficient moisture has been evaporated, i.e. the product will only be able to travel through the restriction in cross-sectional area and/or radius once the centrifugal force has been overcome.

As the product is lifted into the diffuser section (once sufficient moisture has been evaporated), the velocity of the product (and the associated gas flow) will decrease due to the increasing cross-sectional area and the product will thus exit through the product outlet 103.

As mentioned previously, the flash dryer 100 may be further configured to disintegrate the product during the drying process. To achieve this disintegration of the product (e.g. from a paste-like structure to a particle structure and/or from larger particles to smaller particles) the flash dryer 100 may comprise a disintegrator 107 such as a rotary disintegrator, a mill, and/or an impeller rotor.

For example, the disintegrator 107 may be a rotary disintegrator comprising one or more rotating disintegrator elements. Each of the disintegrator elements may comprise an arm extending from a central shaft, and one or more wings or blades or other surfaces or structures for disintegrating the product.

The number of disintegrator elements, as well as the size and shape of the disintegrator elements may be determined in dependence on the product to be dried, e.g. if the product has a paste-like structure, a sludge-like structure, a particle structure, or the like, to achieve a desired disintegration of the product. The rotation speed of the disintegrator 107 may similarly be determined in dependence on the product to be dried.

The disintegrator 107 may be configured to fling the product to be dried against the chamber wall 105 so as to disintegrate the product by collision with the disintegrator elements and/or the chamber wall 105. The disintegrator 107 may additionally, or alternatively, be configured to cut and/or grind the material, for example using disintegrator elements with edges (e.g. sharp edges), counter-rotating disintegrator elements, and/or rotating disintegrator elements configured to grind the product against stationary grinding elements 110 located on the chamber wall 105.

The disintegrator 107 may be located at the same vertical height, or below, the product inlet 102. Preferably, the disintegrator 107 is located at the same vertical height as the product inlet 102, such that the rotating disintegrator elements strike or hit the product as the product enters the chamber 101.

The rotating disintegrator 107 induces a rotational or tangential component to the gas flow in the drying portion of the chamber 101. That is, the rotating disintegrator 107 causes the gas flow to have a tangential or rotational velocity. The rotational or tangential velocity, in addition to the vertical velocity of the gas flow through the passage 202, causes the gas to spiral in the drying portion of the chamber 101. The product to be dried, which is carried by the gas flow, thus also undergoes a spiraling motion in the drying portion of the chamber 101. Accordingly, the product to be dried experiences a centrifugal or inertial force due to the spiraling motion caused by the spiraling gas flow. The product is thus pressed radially outwards against the chamber wall 105. In other words, the product will, due to the tangential velocity imposed by the rotating disintegrator 107, be pressed by a centrifugal or inertia force against the wall of the chamber 101.

It will be appreciated that the tangential velocity, and in turn the centrifugal or inertia force experienced by the product, may be controlled by the rotational speed of the rotating disintegrator 107.

Additionally, or alternatively, the tangential velocity may be increased by a secondary tangential gas flow being introduced into the drying portion of the chamber 101. For example, the drying portion of the chamber 101 may comprise one or more tangential gas inlets configured to supply gas in a tangential direction.

The length of the arms of the disintegrator elements may be larger than a radius of the gas distribution element 106, but smaller than a radius of the chamber 101. The disintegrator elements may thus extend at least partly over the passage 202, such that, when the product is carried upwards by the gas coming through the passage 202, the product will be forced into the disintegrator elements causing the product to be efficiently disintegrated.

To ensure that the product reaches the passage 202 and/or the disintegrator elements, an upper surface of the gas distribution element 106 may be inclined relative to the horizontal. The inclined surface may thus guide any product that falls onto the gas distribution element 106 to slide outwards (under the influence of gravity) towards the passage 202 and thereby be lifted by the upwards flow of gas flowing through the passage 202.

Additionally, or alternatively, the flash dryer 100 may comprise one or more shovel arms, such as rotating shovel arms, for pushing the product towards the passage 202.

To drive (i.e. rotate) the rotary disintegrator 107 and/or the shovel arm, the flash dryer 100 may comprise at least one drive unit 108. It has been found particularly advantageous to accommodate the drive unit 108 inside the gas distribution element 106. Thus, the gas distribution element 106 may be formed by an outer wall defining an internal cavity of the gas distribution element 106. The drive unit 108 may accordingly be arranged inside the internal cavity of the gas distribution element 106. A drive shaft, to which the disintegrator 107 and/or shovel arm is connected, may protrude from an upper surface of the gas distribution element 106.

By housing the drive unit 108 inside the gas distribution element 106, there is no need for additional axles and/or transmission arrangements. In particular, it is not necessary to have an axle extending through the gas distribution element 106 (e.g. extending from a lower side of the gas distribution element 106 where a drive unit 108 is located to an upper side of the gas distribution element 106 where the drive shaft is located). There is further no need for an externally located drive unit 108 with axles extending into the chamber 101. The placement of a gas inlet 104 directly below the gas distribution element 106 may thus be facilitated.

A drive unit 108 comprising a hydraulic and/or electric motor has been found particularly advantageous when arranged inside the gas distribution element 106.

The flash dryer 100 may further comprise one or more fluid circuits 111 for providing a liquid to the drive unit 108. For example, the fluid circuits 111 may include a hydraulic fluid circuit for providing a hydraulic fluid to a hydraulic motor. Additionally, or alternatively, the fluid circuits 111 may include a cooling circuit for providing a cooling liquid to the drive unit 108 to ensure that the drive unit 108 is not overheated. The fluid circuits 111 may be connected between the cavity of the gas distribution element 106 and an external side of the chamber 101. For example, the fluid circuits 111 may run at least partly through the fixation elements 201.

The flash dryer 100 may further comprise one or more adjustable flaps 109. The adjustable flaps 109 may be configured to control and/or adjust a tangential or rotational velocity of the gas flow in the chamber 101.

The flaps 109 may be located in the drying portion of the chamber 101. That is, the flaps 109 may be located above the gas distribution element 106 and/or above the passage 202. Preferably, the flaps 109 are located above any component of the flash dryer 100 inducing a tangential flow velocity to the gas flow. For example, the flaps 109 may be located above the rotary disintegrator 107 and/or above any tangential gas flow inlets. Preferably, the flaps 109 are located in a lower part of the drying portion of the chamber 101, e.g. just above the disintegrator 107.

The flaps 109 may be arranged along the circumference or periphery of the chamber 101, e.g. along the inner wall 105 of the chamber. For example, the flaps 109 may protrude from the inner wall 105 of the chamber 101. The flaps 109 may be arranged rotationally symmetrically along the circumference or periphery of the chamber 101.

The flaps 109 may comprise deflecting means 203, such as one or more vanes, wing, plates, or the like configured to guide or deflect the gas flow in the drying portion of the chamber 101. The flaps 109 may thus complement and/or act as an alternative to the rotating disintegrator 107 and/or a tangential air inlet in inducing or maintaining a tangential gas flow velocity.

The flaps 109 may be adjustable by rotation. That is, an inclination of a main plane of the deflecting means 203 (e.g. a plane of the wing, plate, or vane of the flaps) may be adjusted by rotation. In other words, an angle of attack of the flaps 109 relative to the incoming gas flow through the passage 202 may be adjusted by rotation.

The flaps 109 may be adjustable in a continuous manner, e.g. between two or more positions, and/or in discrete steps, e.g. between two or more discrete predetermined positions.

For example, the flaps 109 may be adjustable between at least a first position and a second position. The first position may correspond to an inclined orientation of the flaps 109 where the flaps 109 are inclined relative to the gas flow through the passage 202 so as to allow a tangential velocity of the gas flow.

In the first position, the flaps 109 may have (i) an inclination that is more horizontal than the incoming gas flow such that the gas is deflected in a tangential direction so as to increase a tangential velocity of the gas flow, (ii) an inclination that is more vertical than the incoming gas flow such that the gas is deflected in an axial direction so as to reduce (but not remove) a tangential velocity of the gas flow, and/or (iii) an inclination substantially similar to the incoming gas flow such that a tangential gas flow velocity is maintained.

By controlling the tangential velocity of the gas flow, a drying time of the product may be controlled. That is, the time required for the product to reach the product outlet 103 may be controlled by the use of the adjustable flaps 109. Because the centrifugal force acting on the product is dependent on the tangential gas flow velocity.

The second position, on the other hand, may correspond to a substantially vertical orientation of the flaps 109 so as to restrict, limit, or remove a tangential velocity of the gas flow.

The positioning of the flaps 109 in the second position has been found to facilitate the start-up and shut-down procedures of the flash dryer 100.

For example, the adjustable flaps 109 facilitate emptying of the chamber 101 (i.e. removal of product from the chamber 101 through the product outlet 103), e.g. when the system is shut down. In particular, a time required to empty the chamber 101 may be reduced.

When emptying conventional flash dyers, the rotational speed of the rotary disintegrator is slowly reduced, typically over a period of at least 30 minutes. This run-down of the rotary disintegrator gradually reduces the tangential velocity of the gas flow and/or product in the chamber. As the tangential velocity is reduced, the centrifugal force acting on the product decreases. Accordingly, when the centrifugal force has been sufficiently decreased, the product may rise upwards in the chamber towards the product outlet, thus allowing the chamber to be emptied.

However, the adjustable flaps 109 according to embodiments reduces and/or removes the need for a slow run-down of the rotary disintegrator 107, thus reducing the time required to empty the chamber 101. The reduction in centrifugal force required to allow the product to travel upwards to the product outlet 103 is, in embodiments, instead achieved by positioning the flaps 109 in a substantially vertical position. When the flaps 109 are in the vertical position, the tangential gas flow component is reduced and/or removed. That is, the gas flow becomes a predominantly axial gas flow. Hence, the vertical positioning of the flaps 109 allows the product to flow upwards to the product outlet 103 without having to slowly reduce the rotational speed of the rotary disintegrator 107.

As previously mentioned, the adjustable flaps 109 according to embodiments, have further been found to facilitate a start-up procedure of the flash dryer 100. When the flash dryer 100 is started, the rotational speed of the rotary disintegrator 107 is typically slowly increased up to its fully operational speed. During this time, any product being introduced in the chamber 101 may flow to the product outlet 103 too quickly, i.e. before sufficient moisture has been evaporated. This is due to the centrifugal force acting on the product being too low since the rotary disintegrator 107 has not yet induced sufficient tangential velocity to the gas flow and/or product. Thus, as the product is not pushed outward by a sufficient centrifugal force, it will flow axially towards the product outlet 103 in less time than is required to evaporate sufficient moisture in the product by the hot gas.

However, in embodiments, the adjustable flaps 109 may be used to increase the tangential flow and hence the centrifugal force acting on the particles. By positioning the flaps 109 in a substantially horizontal orientation, the flaps 109 will deflect the gas flow in a tangential direction increasing the tangential gas flow velocity. Hence, a sufficient centrifugal force may be achieved even during a start-up phase of the rotary disintegrator 107.

In embodiments, the adjustable flaps 109 may be configured to be adjustable between one or more positions, in addition or as an alternative to the first and/or second position, corresponding to one or more of the orientations (i)-(iii) outlined above. For example, the flaps 109 may be adjustable between three positions or orientations: a first position for increasing or maintaining the tangential velocity of the gas flow, a second position for reducing the tangential velocity of the gas flow, and a third position for removing a tangential velocity of the gas flow.

The flash dryer 100 may comprise a control system for adjusting the flaps 109. Alternatively, or additionally, the flaps 109 may be configured to be adjusted by a user, e.g. by manual adjustment. In such a case, the flaps 109 may comprise manual adjustment means 204, such as an adjusting means protruding through the chamber wall 105 to an exterior side of the chamber 101. A user may thus adjust the flaps 109 from outside of the chamber 101.

Although described in relation with the flash dryer 100 according to embodiments (i.e. a flash dryer 100 with a gas distribution element), the adjustable flaps 109 may be used in combination with any suitable flash dryer, for example in conventional flash dryers.

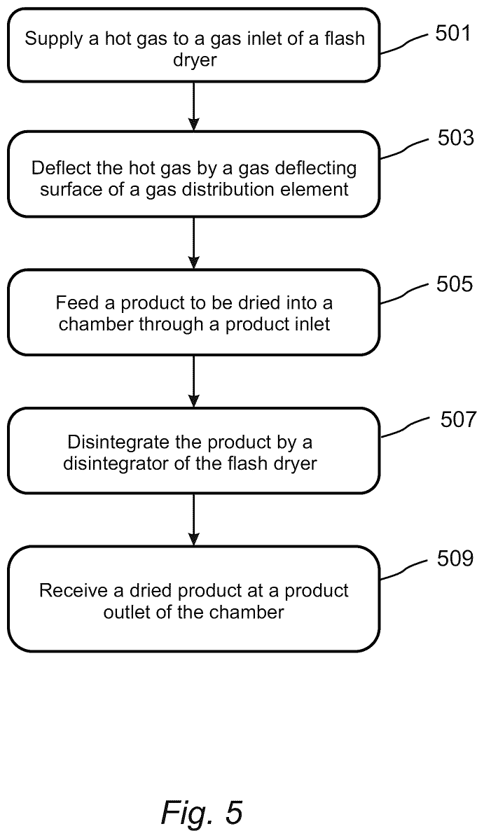

FIG. 5 shows a method of drying a product in a flash dryer 100. The flash dryer 100 may be a flash dryer as previously described or any other suitable flash dryer.

In step 501, a hot gas is supplied to the gas inlet 104. After being supplied at the gas inlet 104, the hot gas flows towards the gas distribution element 106.

In step 503, the hot gas is deflected by the gas deflecting surface of the gas distribution element 106. In particular, the hot gas is deflected towards the passage 202 formed between the gas distribution element 106 and the chamber wall 105. At the passage 202, the gas flow accelerates and flows in a substantially vertical direction into the drying portion of the chamber 101.

In step 505, the product to be dried is fed into the chamber 101 of the flash dryer 100 through the product inlet 102. The product to be dried is subjected to the hot gas flow coming from the passage 202 and is carried upwards by the gas flow. As the product is carried by the gas flow, the hot gas causes moisture in the product to be evaporated.

In step 507, the product comes into contact with the disintegrator 107 causing the product to be disintegrated into smaller particles. The disintegrator 107 also induces a rotational velocity to the gas flow and in turn to the product. The product will thus spiral in the chamber 101 as moisture is evaporated. As more and more moisture is evaporated, the product will be carried further up in the chamber 101.

In step 509, the product will exit the chamber 101 through the product outlet 103 once a sufficient amount of moisture has been evaporated.

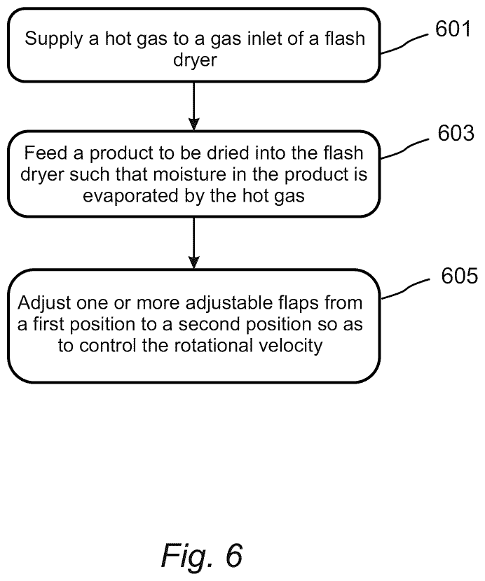

FIG. 6 shows a method of drying a product in a flash dryer 100. The flash dryer comprises one or more adjustable flaps 109. The flash dryer may be a flash dryer 100 as previously described or any other suitable flash dryer.

In step 601, a hot gas is supplied to the gas inlet 104.

In step 603, the product to be dried is fed into the chamber 101 of the flash dryer 100 through the product inlet 102. The product to be dried is subjected to the hot gas flow and is carried upwards by the gas flow. As the product is carried by the gas flow, the hot gas causes moisture in the product to be evaporated.

In step 605, one or more flaps 109 are adjusted from a first position to a second position. Thus, a tangential velocity of the flow of gas is controlled by the adjustable flaps 109. For example, the flaps 109 may be adjusted to a position where the flaps 109 are substantially vertical such that the flaps 109 deflect the gas flow so as to reduce a tangential velocity of the gas flow. Thus, the centrifugal force acting on the circulating product in the chamber 101 is reduced allowing the product to exit the chamber 101 through a product outlet 103. As another example, the flaps 109 may be adjusted to a position where the flaps 109 are substantially horizontal such that the flaps 109 cause an increase in tangential velocity of the gas flow, thereby increasing the centrifugal force acting on the product.

Step 605 may additionally comprise inducing a rotational velocity to the gas flow and in turn to the product. The rotational velocity may be induced by one or more adjustable flaps (e.g. in a first position or orientation), by a rotary disintegrator, and/or by additional gas flow from a tangential gas flow inlet. The product will thus spiral in the chamber 101 as moisture is evaporated. As more and more moisture is evaporated, the product will be carried further up in the chamber 101.

The various embodiments described above are provided by way of illustration only and should not be construed to limit the invention. For example, the principles herein may be applied to any flash dryer. Those skilled in the art will readily recognize various modifications and changes that may be made to the present invention without following the example embodiments and applications illustrated and described herein, and without departing from the scope of the present disclosure.

Throughout this specification, the word “may” is used in a permissive sense (i.e. meaning having the potential to), rather than in the mandatory sense (i.e. meaning must).

Throughout this specification, the words “comprise”, “include”, and variations of the words, such as “comprising” and “comprises”, “including”, “includes”, do not exclude other elements or steps.

As used throughout this specification, the singular forms “a”, “an”, and “the”, include plural referents unless explicitly indicated otherwise. Thus, for example, reference to “an” element includes a combination of two or more elements, notwithstanding use of other terms and phrases for one or more elements, such as “one or more” or “at least one”.

The term “or” is, unless indicated otherwise, non-exclusive, i.e. encompassing both “and” and “or”. For example, the feature “A or B” includes feature “A”, feature “B” and feature “A and B”.

Unless otherwise indicated, statements that one value or action is “based on”, “in response to” and/or “in dependence on” another condition or value or action, encompass both instances in which the condition or value or action is the sole factor and instances where the condition or value or action is one factor among a plurality of factors.

Unless otherwise indicated, statements that “each” instance of some collection have some property should not be read to exclude cases where some otherwise identical or similar members of a larger collection do not have the property, i.e. each does not necessarily mean each and every.

The invention claimed is:

1. A flash dryer for drying a product, the flash dryer comprising:
a chamber formed of a chamber wall;
a product inlet for providing the product into the chamber;
a gas inlet arranged below the product inlet for providing drying gas into the chamber;
an outlet arranged above the product inlet; and
a gas distribution element arranged above the gas inlet;
wherein an outer edge of the gas distribution element is distanced from the chamber wall such that a passage is formed between the gas distribution element and the chamber wall; and
wherein a lower side of the gas distribution element includes a gas deflecting surface inclined relative to a horizontal plane such that the drying gas from the gas inlet is deflected by the gas deflecting surface towards the passage.

2. The flash dryer according to claim 1, wherein the gas inlet is arranged vertically below the gas distribution element.

3. The flash dryer according to claim 1, wherein the gas inlet is arranged to provide a substantially vertical gas flow into the chamber before the gas flow is deflected by the gas deflecting surface.

4. The flash dryer according to claim 1, wherein the gas inlet is a centrally arranged gas inlet.

5. The flash dryer according to claim 1, wherein the gas deflecting surface is inclined, relative to a horizontal plane, between a first section near the outer edge and a second section away from the outer edge such that the second section is located below the first section.

6. The flash dryer according to claim 1, wherein the chamber is a cylindrical chamber;
wherein the passage is an annular passage; and
wherein the gas distribution element and/or the gas deflecting surface is rotationally symmetric.

7. The flash dryer according to claim 1, wherein the gas distribution element is formed by an outer wall defining an internal cavity;
wherein a drive unit is arranged inside the internal cavity of the gas distribution element; and
wherein the drive unit is connected to a drive shaft extending through an upper surface of the gas distribution element into the chamber.

8. The flash dryer according to claim 7, wherein the gas distribution element is provided with one or more fluid circuits connected to the drive unit; and
wherein the flash dryer is configured to circulate cooling fluid through the fluid circuits to cool the drive unit.

9. The flash dryer according to claim 8, further comprising one or more rotatable disintegrator elements arranged above the gas distribution element and connected to the drive shaft.

10. The flash dryer according to claim 1, further comprising one or more adjustable flaps arranged in the chamber for controlling a tangential velocity of the gas flow.

11. The flash dryer according to claim 10, wherein the adjustable flaps are adjustable between a first position and a second position;
wherein in the first position a plane of each flap is inclined relative to a vertical plane; and
wherein in the second position the plane of each flap is substantially vertical.

12. The flash dryer according to claim 10, wherein the flaps are located above the passage.

13. A flash dryer for drying a product, the flash dryer comprising:
a chamber formed of a chamber wall;
a product inlet for providing the product into the chamber;
a gas inlet arranged below the product inlet for providing drying gas into the chamber;
an outlet arranged above the product inlet; and
one or more adjustable flaps arranged in the chamber for controlling a tangential velocity of the gas flowing through the chamber.

14. The flash dryer according to claim 13, wherein the adjustable flaps are adjustable between a first position and a second position;
wherein in the first position a plane of each flap is inclined relative to a vertical plane; and
wherein in the second position the plane of each flap is substantially vertical.

15. The flash dryer according to claim 13, wherein the adjustable flaps are arranged on the chamber wall.

16. The flash dryer according to claim 13, wherein the flaps are adjustable between:
a position for increasing the tangential velocity of the gas flow; and/or
a position for maintaining the tangential velocity of the gas flow; and/or
a position for reducing the tangential velocity of the gas flow, and/or
a position for removing the tangential velocity of the gas flow.

17. The flash dryer according to claim 13, further comprising a control system for adjusting the flaps.

18. The flash dryer according to claim 13, further comprising a gas distribution element arranged above the gas inlet;
wherein an outer edge of the gas distribution element is distanced from the chamber wall such that a passage is formed between the gas distribution element and the chamber wall;
wherein the flaps are located above the passage.

19. The flash dryer according to claim 13, further comprising one or more rotatable disintegrator elements;
wherein the flaps are located above the one or more disintegrator elements.

20. A method of drying a product in a flash dryer, the method comprising:
supplying a hot gas to a gas inlet of a chamber;
deflecting the hot gas, by a gas deflecting surface of a gas distribution element towards a passage formed between the gas distribution element and a wall of the chamber such that the gas flows through the passage;
feeding the product into the chamber through a product inlet;
carrying the product upwards by the gas flowing through the passage;
evaporating moisture in the product by the hot gas; and
collecting the product at a product outlet of the chamber.
